(19) United States
(12) Patent Application Publication
(10) Pub. No.: US 2015/0302341 A1
(43) Pub. Date: Oct. 22, 2015

(54) SYSTEM FOR IMPLEMENTING CHANGE CONDITION LEVELS

(71) Applicant: BANK OF AMERICA CORPORATION, Charlotte, NC (US)

(72) Inventors: Robert J. Maloney, Iron Station, NC (US); James J Micek, Sewell, NJ (US); James W. Faile, JR., Charlotte, NC (US); Jodi L. Petersen-Cannon, St. Louis, MO (US); Zachary Lee Clay, Indianapolis, IN (US); Neil John Aldridge, New Canaan, CT (US); Michelle Lofgren, San Francisco, CA (US)

(73) Assignee: BANK OF AMERICA CORPORATION, Charlotte, NC (US)

(21) Appl. No.: 14/258,601

(22) Filed: Apr. 22, 2014

(51) Int. Cl. G06Q 10/06

(52) U.S. Cl. CPC G06Q 10/063114

(57) ABSTRACT

Disclosed is a system for implementing change condition levels. The system for implementing change condition levels typically includes a processor, a memory, and a change event management module stored in the memory. The system for implementing change condition levels is typically configured for: receiving an indication of a change event to be implemented; determining that a change condition level is applicable to the change event; based on determining that the change condition level is applicable to the change event, initiating a change event approval process for a change event, the change event approval process being defined by the change condition level; and, once the approval process has been successfully completed, permitting implementation of the change event, implementation of the change event being prohibited until receiving the indication of the successful completion of the change event approval process for the change event.

### FIELD OF THE INVENTION

The present invention embraces a system for implementing change condition levels. The system typically includes a processor and a memory. The system also typically includes change event management module stored in the memory, which is typically configured for: initiating a change event approval process for a change event, the change event approval process being defined by the change condition level applicable to the change event; and, once the approval process has been successfully completed, permitting implementation of the change event, implementation of the change event being prohibited until receiving the indication of the successful completion of the change event approval process.

### BACKGROUND

Various methods exist to help businesses manage change events. That said, a need exists for an improved system for managing change events.

### SUMMARY

In one aspect, the present invention embraces a system for implementing change condition levels and an associated method and computer program product. The system for implementing change condition levels typically includes a processor and a memory. The system for implementing change condition levels also typically includes a change event management module stored in the memory and executable by the processor. In one embodiment, the change event management module is configured for: receiving a first change condition level definition for a first change condition level, the first change condition level definition defining a first change event approval process for the first change condition level; receiving an indication that the first change condition level definition is applicable to a first change event category; receiving an indication of a first change event to be implemented; determining that the first change condition level is applicable to the first change event based on the first change event being within the first change event category; based on determining that the first change condition level is applicable to the first change event, initiating the first change event approval process for the first change event; receiving an indication of the successful completion of the first change event approval process for the first change event; and based on receiving the indication of the successful completion of the first change event approval process for the first change event, permitting implementation of the first change event, implementation of the first change event being prohibited until receiving the indication of the successful completion of the first change event approval process for the first change event.

In one embodiment, the change event management module is configured for: receiving an indication that the change condition level applicable to the first change event has been raised from the first change condition level to a second change condition level, a second change condition level definition defining a second change event approval process for the second change condition level; based on receiving the indication that the change condition level applicable to the first change event has increased, initiating the second change event approval process for the first change event; receiving an indication of the successful completion of the second change event approval process for the first change event; based on receiving the indication of the successful completion of the second change event approval process for the first change event, permitting implementation of the first change event, implementation of the first change event being prohibited until receiving the indication of the successful completion of the second change event approval process for the first change event.

In another embodiment, the first change condition level definition defines a second change event approval process; the change event management module is configured for receiving risk information associated with the first change event; and initiating the first change event approval process for the first change event is based on the risk information associated with the first change event.

In a particular embodiment, the first change event approval process defines a more rigorous approval process than the second change event approval process; and initiating the first change event approval process for the first change event is based on the risk information associated with the first change event indicating that the first change event is a high-risk change event.

In yet another embodiment, the first change condition level definition defines a second change event approval process; the change event management module is configured for receiving importance information associated with the first change event; and initiating the first change event approval process for the first change event is based on the importance information associated with the first change event.

In a particular embodiment, the second change event approval process is configured to block change events to which the second change approval process is applicable from being implementing so that such change events cannot be approved as long as the second change approval process is applicable to such change events; and initiating the first change event approval process for the first change event is based on the importance information associated with the first change event indicating that the first change event is an importance change event.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a system for implementing change condition levels and operating environment in accordance with an exemplary embodiment of the present invention;

FIG. 2 schematically depicts a system for implementing change condition levels in accordance with an exemplary embodiment of the present invention;

FIG. 3 depicts a method of implementing change condition levels in accordance with an exemplary embodiment of the present invention; and

FIG. 4 depicts a method of implementing change condition levels where the change condition level has increased in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, assess management firms, insurance companies and the like. In specific embodiments of the invention, use of the term “bank” is limited to a financial entity in which account-bearing customers conduct financial transactions, such as account deposits, withdrawals, transfers and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that engage in risk assessment and management.

A “user” may be any person or entity using a system for implementing change condition levels described herein. Often, a user is an employee of an entity (e.g., a financial institution) using a system for implementing change condition levels. In some instances a user has a management position within an entity using a system for implementing change condition levels.

As used herein, the term “program” relates to a large body of work that has the goal of achieving one or more business outcomes. A program may have a defined beginning and end or may be ongoing. In contrast, the term “project” relates to an endeavor within a program undertaken to provide one or more outputs. These outputs typically help to achieve one or more business goal of an overarching program. While a program is often ongoing, projects typically have a defined beginning and end.

As used herein, the term “change event” relates to a discrete change to a business asset, system, process, product, or the like. Exemplary change events may include installing new hardware in an existing entity system, updating software used by the entity, implementing a procedural change to a business process, rolling out a new product or service, or updating the entity's website. Change events often occur as part of the execution of a program or project.

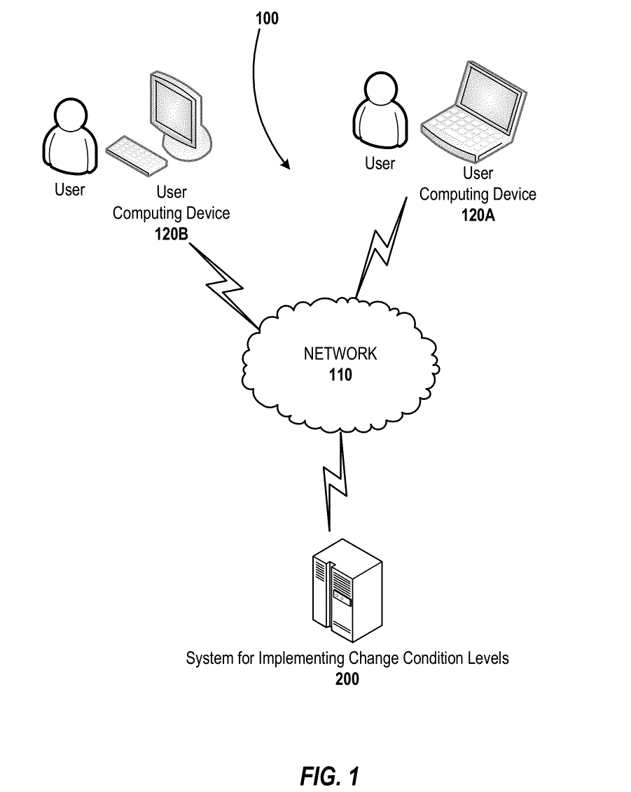

In one aspect, the present invention embraces a system for implementing change condition levels that may be used by an entity, such as a financial institution, to regulate the implementation of change events in a way that mitigates risk. In particular, the system for implementing change condition levels may be used to regulate the implementation of change events depending on change condition levels, which may reflect the risks associated with such change events. In this regard, FIG. 1 depicts an operating environment 100 according to one embodiment of the present invention that implements change condition levels for an entity (e.g., a financial institution). The operating environment includes a system 200 for implementing change condition levels. In addition, one or more users, each having a user computing device 120, such as a PC, laptop, mobile phone, tablet, television, mobile device, or the like, may be in communication with the system 200 for implementing change condition levels via a network 100, such as the Internet, wide area network, local area network, Bluetooth network, near field network, or any other form of contact or contactless network.

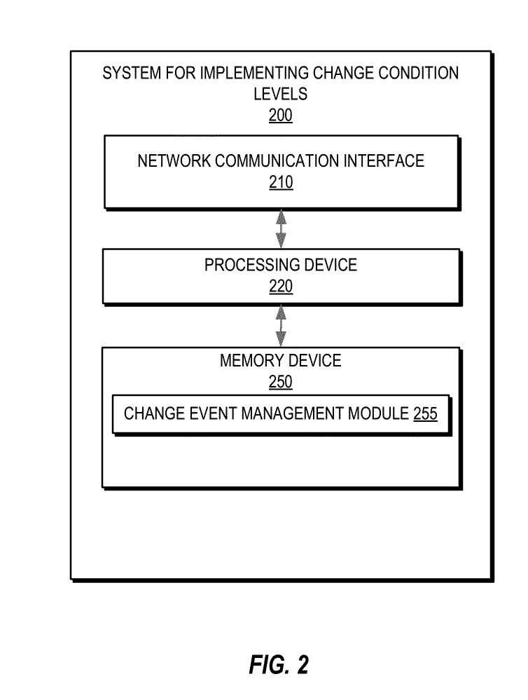

FIG. 2 depicts the system 200 for implementing change condition levels in more detail. As depicted in FIG. 2 the system 200 for implementing change condition levels typically includes various features such as a network communication interface 210, a processing device 220, and a memory device 250. The network communication interface 210 includes a device that allows the system 200 for implementing change condition levels to communicate over the network 110 (shown in FIG. 1) with the user computing devices 120. In this regard, an interface (e.g., a graphical user interface) is typically presented on each user computing device to allow each user to interact with the system 200 for implementing change condition levels. The system 200 may interact with other entity systems, such as program or project management systems and/or asset management systems, which may be used to manage the planning and/or implementation of change events.

As used herein, a “processing device,” such as the processing device 220, generally refers to a device or combination of devices having circuitry used for implementing the communication and/or logic functions of a particular system. For example, a processing device 220 may include a digital signal processor device, a microprocessor device, and various analog-to-digital converters, digital-to-analog converters, and other support circuits and/or combinations of the foregoing. Control and signal processing functions of the system are allocated between these processing devices (e.g., processors) according to their respective capabilities. The processing device 220 may further include functionality to operate one or more software programs based on computer-executable program code thereof, which may be stored in a memory. As the phrase is used herein, a processing device 220 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 250, generally refers to a device or combination of devices that store one or more forms of computer-readable media for storing data and/or computer-executable program code/instructions. Computer-readable media is defined in greater detail below. For example, in one embodiment, the memory device 250 includes any computer memory that provides an actual or virtual space to temporarily or permanently store data and/or commands provided to the processing device 220 when it carries out its functions described herein.

As noted, the system 200 for implementing change condition levels is typically configured to implement change condition levels in order to manage change events. Accordingly, the system 200 for implementing change condition levels typically includes one or more modules stored in the memory device 250, which facilitate change event management. As depicted in FIG. 2, the system 200 typically includes a change event management module 255.

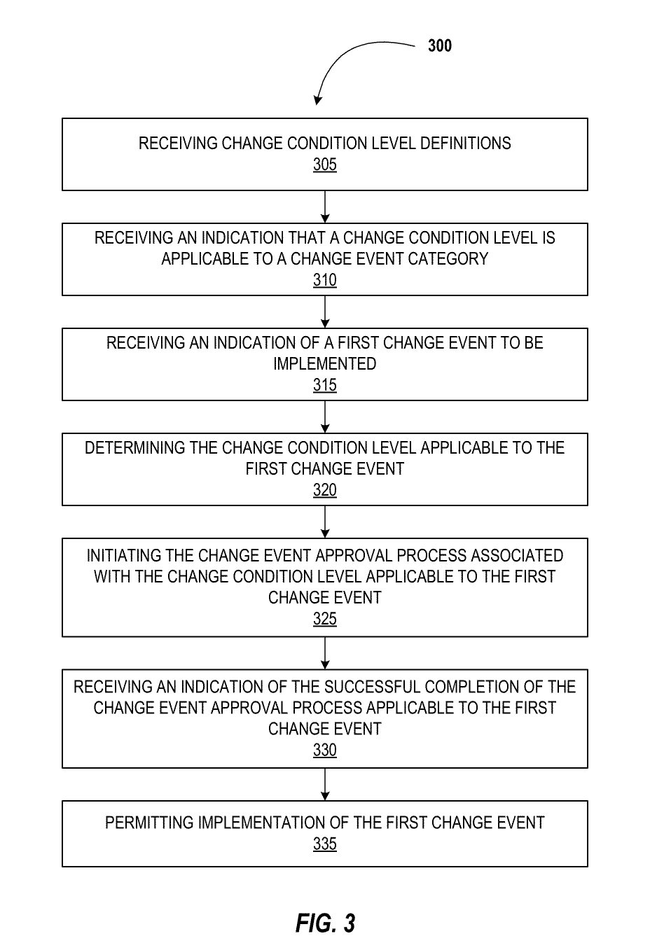

The change event management module 255 is typically configured so that one or more users can interact (e.g., via user computing devices) with the system 200 for implementing change condition levels in order to manage risk events. In this regard, FIG. 3 depicts a method 300 of implementing change condition levels that may be performed by the change event management module 255.

Accordingly, at block 305, the change event management module 255 is typically configured to initially receive one or more change condition level definitions, each definition being associated with a different change condition level. Each change condition level definition typically defines a change event approval process for its change condition level. In particular, each change event approval process typically specifies those individuals or organizations within the entity that must review and approve change events that fall within a particular change condition level. In some embodiments, approval from multiple individuals and/or organizations may be required.

In some embodiments, a change condition level definition may include a plurality of different change event approval processes, where the change event approval process applicable to a particular change event may further depend upon risk information associated with the change event or importance information associated with the change event. The change event risk information may include information (e.g., the degree of risk) associated with one or more risk factors. Exemplary risk factors may include: the degree of employee impact, the degree of client/customer impact, reputational impact if event is unsuccessful, financial impact if event is unsuccessful, whether the event is an independent deployment during but not part of a release, technological complexity, the impact on critical business processes or systems, whether the event is in response to a regulatory requirement, the degree to which the event impacts multiple lines of business, the impact on critical business processes or systems within a single line of business, the impact on important entity applications, the degree of impact on particular customer, client, or employee groups or subgroups, and the volume and importance of customer transactions impacted. The change event risk information may indicate whether a change event is a high-risk or low-risk change event. The change event importance information may relate to the importance (e.g., criticality) of implementing a change event. For example, a change event may be important or critical if it is being performed to correct a severe break in an entity system, is contractually required, or is needed to address an expiring software certification.

In an exemplary embodiment, there may be four different change condition levels. A first change condition level may define a change event approval process that requires review and approval of change events in accordance with the entity's standard procedures (i.e., business as usual operations). A second change condition level may define a change event approval process that requires (i) elevated review and approval (e.g., executive approval, such as by a chief technology officer or chief information officer) of high-risk change events (e.g., change events with risk information indicating high risk to the entity, such as a high risk to a critical business process or system) and (ii) approval in accordance with the entity's standard procedures for low-risk events. A third second change condition level may define a change event approval process that requires elevated review and approval (e.g., executive approval) of change events. A fourth change condition level may define a change event approval process that (i) requires elevated review and approval (e.g., executive approval) for important change events and (ii) blocks all other change events such that blocked change events cannot be approved as long as the fourth change condition level is in effect. Additionally, the fourth change condition level's change event approval process may be configured to prompt the rescheduling of blocked change events outside of a time period to which the fourth change condition level is applicable.

Next, at block 310, the change event management module 255 typically receives an indication that a change condition level is applicable to one or more change event categories. The change event categories define which types of change events fall under a particular change condition level. A change event category may be all change events or a particular subset of change events occurring during a particular time period and/or related to a common lines of business, common critical business process, common geographic region, common physical location (e.g., building or city), common logical location (e.g., database), common entity system, common customers, and/or common employees.

Typically, the change event management module 255 may initially receive an indication regarding default change condition levels applicable to certain change events categories. For example, by default a first change condition level that requires standard approval procedures may be applicable to most change events categories but a second change condition level that requires elevated approval may be applicable to other change event categories (e.g., those categories of change events with higher expected risks). Thereafter, the change event management module 255 may receive an indication that the change condition level applicable to a certain change event categories should be changed. Typically, the change event management module 255 defines the process for changing the change condition level applicable to a change event category. For example, the change event management module 255 typically defines those individuals and/or organizations within the entity that have the authority to alter the change condition level applicable to certain change event categories. Altering the change condition level applicable to change event categories is typically based on risk information associated with the change event categories. In this regard, those individuals and/or organizations within the entity that have the authority to alter a change condition level applicable to a change event category may regularly review risk information associated with the change event category to assess whether the change condition level should be changed (e.g., raised to a change condition level with a more rigorous change event approval process or lowered to a change condition level with a less rigorous change event approval process). Alternatively, the change event management module 255 may regularly prompt those individuals and/or organizations to provide risk information regarding a number of risk factors (e.g., (i) previous success in implementing change events, (ii) previous success in implementing high-risk change events, (iii) stability of relevant entity systems, particularly the volume of incidents and/or problems, (iv) past adherence to the methodology set forth by the system for implementing change condition levels, and (v) projected future risk, which may be based on future planned significant deployment events and/or the volume of planned future change events, especially those change events impacting critical entity systems) applicable to the change event category. Based on provided risk information, the change event management module 255 may determine a change event category risk score that can be used by the change event management module 255 to determine whether to raise or lower the change condition level applicable to the change event category.

At block 315, the change event management module 255 receives an indication (e.g., from a user via a program or project management system and/or asset management system) of a first change event that a user wishes to implement. The indication of the first change event may include additional information regarding the first change event, such as risk information, importance information, timing information, category information, and the like.

At block 320, the change event management module 255 typically determines the change condition level applicable to the first change event. This determination is typically based on matching a change event category associated with the first change event with a change event category associated with a change condition level. The change event category associated with the first change event may be received with the indication of the first change event or may be determined by the change event management module 255 (e.g., by retrieving change event category information from a database associating change events with respective change event categories). In the event that multiple change condition levels are potentially applicable to the first change event (e.g., because the first change event falls within multiple change event categories associated with different change condition levels), the change event management module 255 will typically determine that the most rigorous change condition level is applicable to the first change event (i.e., the change condition level having the most rigorous change event approval process).

Based on determining the change condition level applicable to the first change event, at block 325, the change event management module 255 typically initiates the change event approval process applicable to the change condition level (e.g., as defined by the relevant change condition level definition). For example, the change event management module 255 may communicate with the individuals and/or organizations whose review and approval is required by the applicable change event approval process in order to request their review and approval of the first change event. If the change condition level defines multiple change event approval processes (e.g., approval processes that depend on change event importance or change event risk information), then this step further includes determining which of the change condition level's change event approval processes is applicable to the change event. For example, if the applicable change condition level has two change event approval processes, one for high-risk events and one for low-risk events, then the change event management module 255 will initiate the change event approval process appropriate for the change event's risk information (e.g., risk information received with the indication of the change event to be implemented or risk information retrieved by the change event management module 255).

Once the change event approval process has been implemented with respect to the first change event, the change event management module 255 will typically wait to receive an indication of the successful completion of the change event approval process. Typically, the change event management module 255 will block (e.g., prohibit) the implementation of the first change event until the change event approval process has been successfully completed. In this regard, the change event management module 255 may interact with an entity program or project management system or asset management system to block implementation of change event via the program or project management system or asset management system.

At block 330, the change event management module 255 receives an indication of the successful completion of the change event approval process applicable to the first change event. For example, the change event management module 255 may receive a communication from all the individuals and/or organizations whose review and approval is required by the applicable change event approval process.

As noted, in some embodiments, the change event approval process may entirely block certain change events from being approved. For such change events, the change event approval process cannot be successfully completed as long as such change event approval process is applicable to such change events. If, however, the change condition level applicable to such change events changes, then approval may be achieved by successful completion of the newly applicable change event approval process. In this regard, the applicable change condition level may change based on rescheduling such change events if the initial change condition level is applicable to only a certain time period. Alternatively, the change event management module 255 may receive an indication that the change condition level applicable to the relevant categories of such change events has changed.

Based on receiving the indication of the successful completion of the change event approval process applicable to the first change event, at block 335, the change event management module 255 permits the implementation of the first change event (e.g., by interacting with an entity program or project management system or asset management system).

As previously described, the change condition level applicable to a change event category may change. Accordingly, in some instances the change condition level applicable to a change event may change after a change event has been approved, but before the change event has been implemented. If the applicable change condition level has been lowered, then no further action would typically be taken by the change event management module 255 with respect to the approved changed event.

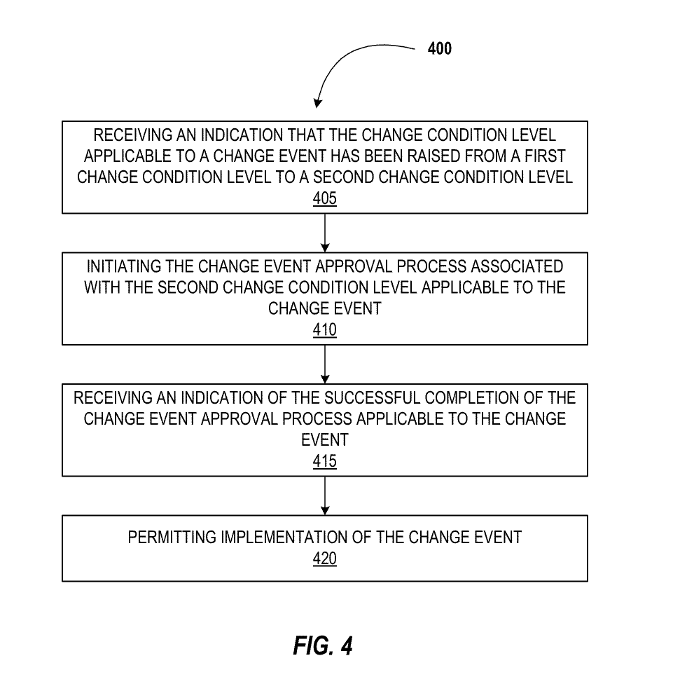

However, if the applicable change condition level has been raised, then the change event management module 255 will typically require that the change event be reapproved in accordance with the change event approval process of the raised change condition level. In this regard, FIG. 4 depicts a method for reapproving a change event where the applicable change condition level has been raised in accordance with an aspect of the present invention.

Initially, at block 405, the change event management module 255 receives an indication that the change condition level applicable to the change event has been raised from a first change condition level to a second change condition level. For example, the change event management module 255 may receive an indication that the second change condition instead of the first change condition level is now applicable to a change event category that the change event falls within. Typically, the change event was previously approved in accordance with an approval process associated with the first change condition level but has not yet been implemented.

Based on receiving the indication that the change condition level applicable to the change event has been raised, at block 410, the change event management module 255 initiates the change event approval process associated with the second change condition level applicable to the change event. If the second change condition level has multiple approval processes, then the change event management module 255 typically determines which approval process is applicable to the change event. Typically, the change event management module 255 will block the implementation of the change event until the second change event approval process has been successfully completed.

Subsequently, at block 415, the change event management module 255 receives an indication of the successful completion of the change event approval process applicable to the change event.

Based on receiving the indication of the successful completion of the applicable change event approval process, at block 420, the change event management module 255 permits implementation of the change event.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for implementing change condition levels, comprising:
a processor;
a memory;
a change event management module stored in the memory, executable by the processor and configured for:
receiving a first change condition level definition for a first change condition level, the first change condition level definition defining a first change event approval process for the first change condition level;
receiving an indication that the first change condition level definition is applicable to a first change event category;
receiving an indication of a first change event to be implemented;
determining that the first change condition level is applicable to the first change event based on the first change event being within the first change event category;
based on determining that the first change condition level is applicable to the first change event, initiating the first change event approval process for the first change event;
receiving an indication of the successful completion of the first change event approval process for the first change event; and
based on receiving the indication of the successful completion of the first change event approval process for the first change event, permitting implementation of the first change event, implementation of the first change event being prohibited until receiving the indication of the successful completion of the first change event approval process for the first change event.

2. The system for implementing change condition levels according to claim 1, wherein the change event management module is configured for:
receiving an indication that the change condition level applicable to the first change event has been raised from the first change condition level to a second change condition level, a second change condition level definition defining a second change event approval process for the second change condition level;
based on receiving the indication that the change condition level applicable to the first change event has increased, initiating the second change event approval process for the first change event;
receiving an indication of the successful completion of the second change event approval process for the first change event; and
based on receiving the indication of the successful completion of the second change event approval process for the first change event, permitting implementation of the first change event, implementation of the first change event being prohibited until receiving the indication of the successful completion of the second change event approval process for the first change event.

3. The system for implementing change condition levels according to claim 1, wherein:
the first change condition level definition defines a second change event approval process;
the change event management module is configured for receiving risk information associated with the first change event; and
initiating the first change event approval process for the first change event is based on the risk information associated with the first change event.

4. The system for implementing change condition levels according to claim 3, wherein:
the first change event approval process defines a more rigorous approval process than the second change event approval process; and
initiating the first change event approval process for the first change event is based on the risk information associated with the first change event indicating that the first change event is a high-risk change event.

5. The system for implementing change condition levels according to claim 1, wherein:
the first change condition level definition defines a second change event approval process;
the change event management module is configured for receiving importance information associated with the first change event; and
initiating the first change event approval process for the first change event is based on the importance information associated with the first change event.

6. The system for implementing change condition levels according to claim 5, wherein:
the second change event approval process is configured to block change events to which the second change approval process is applicable from being implementing so that such change events cannot be approved as long as the second change approval process is applicable to such change events; and
initiating the first change event approval process for the first change event is based on the importance information associated with the first change event indicating that the first change event is an importance change event.

7. A computer program product for implementing change condition levels comprising a non-transitory computer-readable storage medium having computer-executable instructions for:
receiving a first change condition level definition for a first change condition level, the first change condition level definition defining a first change event approval process for the first change condition level;
receiving an indication that the first change condition level definition is applicable to a first change event category;
receiving an indication of a first change event to be implemented;
determining that the first change condition level is applicable to the first change event based on the first change event being within the first change event category;
based on determining that the first change condition level is applicable to the first change event, initiating the first change event approval process for the first change event;
receiving an indication of the successful completion of the first change event approval process for the first change event; and
based on receiving the indication of the successful completion of the first change event approval process for the first change event, permitting implementation of the first change event, implementation of the first change event being prohibited until receiving the indication of the successful completion of the first change event approval process for the first change event.

8. The computer program product according to claim 7, wherein the non-transitory computer-readable storage medium has computer-executable instructions for:
receiving an indication that the change condition level applicable to the first change event has been raised from the first change condition level to a second change condition level, a second change condition level definition defining a second change event approval process for the second change condition level;
based on receiving the indication that the change condition level applicable to the first change event has increased, initiating the second change event approval process for the first change event;
receiving an indication of the successful completion of the second change event approval process for the first change event; and
based on receiving the indication of the successful completion of the second change event approval process for the first change event, permitting implementation of the first change event, implementation of the first change event being prohibited until receiving the indication of the successful completion of the second change event approval process for the first change event.

9. The computer program product according to claim 7, wherein:
the first change condition level definition defines a second change event approval process;
the non-transitory computer-readable storage medium has computer-executable instructions for receiving risk information associated with the first change event; and
initiating the first change event approval process for the first change event is based on the risk information associated with the first change event.

10. The computer program product according to claim 9, wherein:
the first change event approval process defines a more rigorous approval process than the second change event approval process; and
initiating the first change event approval process for the first change event is based on the risk information associated with the first change event indicating that the first change event is a high-risk change event.

11. The computer program product according to claim 7, wherein:
the first change condition level definition defines a second change event approval process;
the non-transitory computer-readable storage medium has computer-executable instructions for receiving importance information associated with the first change event; and
initiating the first change event approval process for the first change event is based on the importance information associated with the first change event.

12. The computer program product according to claim 11, wherein:
the second change event approval process is configured to block change events to which the second change approval process is applicable from being implementing so that such change events cannot be approved as long as the second change approval process is applicable to such change events; and
initiating the first change event approval process for the first change event is based on the importance information associated with the first change event indicating that the first change event is an importance change event.

13. A method for implementing change condition levels, comprising:
receiving, via a computer processor, a first change condition level definition for a first change condition level, the first change condition level definition defining a first change event approval process for the first change condition level;
receiving, via a computer processor, an indication that the first change condition level definition is applicable to a first change event category;
receiving, via a computer processor, an indication of a first change event to be implemented;
determining, via a computer processor, that the first change condition level is applicable to the first change event based on the first change event being within the first change event category;
based on determining that the first change condition level is applicable to the first change event, initiating, via a computer processor, the first change event approval process for the first change event;
receiving, via a computer processor, an indication of the successful completion of the first change event approval process for the first change event; and
based on receiving the indication of the successful completion of the first change event approval process for the first change event, permitting, via a computer processor, implementation of the first change event, implementation of the first change event being prohibited until receiving the indication of the successful completion of the first change event approval process for the first change event.

14. The method according to claim 13, comprising:
receiving an indication that the change condition level applicable to the first change event has been raised from the first change condition level to a second change condition level, a second change condition level definition defining a second change event approval process for the second change condition level;
based on receiving the indication that the change condition level applicable to the first change event has increased, initiating the second change event approval process for the first change event;
receiving an indication of the successful completion of the second change event approval process for the first change event; and
based on receiving the indication of the successful completion of the second change event approval process for the first change event, permitting implementation of the first change event, implementation of the first change event being prohibited until receiving the indication of the successful completion of the second change event approval process for the first change event.

15. The method according to claim 13, wherein:
the first change condition level definition defines a second change event approval process;
the method comprising receiving risk information associated with the first change event; and
initiating the first change event approval process for the first change event is based on the risk information associated with the first change event.

16. The method according to claim 15, wherein:
the first change event approval process defines a more rigorous approval process than the second change event approval process; and
initiating the first change event approval process for the first change event is based on the risk information associated with the first change event indicating that the first change event is a high-risk change event.

17. The method according to claim 13, wherein:
the first change condition level definition defines a second change event approval process;
the method comprising receiving importance information associated with the first change event; and
initiating the first change event approval process for the first change event is based on the importance information associated with the first change event.

18. The method according to claim 17, wherein:
the second change event approval process is configured to block change events to which the second change approval process is applicable from being implementing so that such change events cannot be approved as long as the second change approval process is applicable to such change events; and
initiating the first change event approval process for the first change event is based on the importance information associated with the first change event indicating that the first change event is an importance change event.
